(19) United States
(12) Patent Application Publication
(10) Pub. No.: US 2003/0129284 A1
(43) Pub. Date: Jul. 10, 2003

(54) Shrimp ring

(75) Inventor: Dirk Leuenberger, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Admiralty Island Fisheries, Inc. d.b.a. Aqua Star

(21) Appl. No.: 10/044,062

(22) Filed: Jan. 10, 2002

(51) Int. Cl. A23B 4/00

(52) U.S. Cl. 426/129

(57) ABSTRACT

A shrimp container for precooked shrimp has an integral serving tray that slidably receives a transparent cover, the tray and cover cooperatively defining a cavity enclosing a plurality of shrimp. The serving tray includes a cup holder that is surrounded by an annular shelf for supporting the shrimp. A plurality of transverse grooves intersects the shelf radially to drain liquids away from the shrimp. Annular drain grooves disposed at the inner and outer periphery of the shelf receive the drained liquids from the radial grooves. A condiment cup is removably insertable into the cup holder. The cup holder includes a cylindrical wall that extends upwardly higher than the annular shelf, thereby precluding the shrimp from sliding over the cup holder.

### FIELD OF THE INVENTION

The invention is directed to retail food packaging containers, and in particular, to a shrimp container having an integral serving tray.

### BACKGROUND OF THE INVENTION

Food packaging containers for retail applications are well known in the industry, and in particular, it is known to provide a packaging container for shrimp, either fresh or frozen, wherein the container includes an integral serving tray. Shelled, deveined, and precooked shrimp are a popular food item, especially for parties and the like. Such prepared shrimp have several desirable qualities. Shrimp are a flavorful and nutritional food that is suitable as a self-serve “finger food.” Frequently, the inedible tail of the shrimp is left attached to the precooked shrimp, providing a convenient handle for grasping the individual shrimp. Typically, the precooked shrimp are merely thawed (if frozen) and set out on a serving tray, often with a suitable condiment, such as a cocktail sauce.

Shrimp serving trays are known in the art—for example, trays disclosed in U.S. Pat. No. 5,869,120, No. 6,022,571, and No. 6,168,813 to Blazevich. Blazevich discloses one- and two-tier shrimp trays having annular, frustoconical surfaces for supporting the shrimp, a raised annular rim disposed around the surface, and an integral bowl portion for containing a condiment. Blazevich, however, does not disclose any method for packaging a shrimp serving tray with shrimp for retail sales. Moreover, in the trays disclosed by Blazevich, the shrimp tails overhang the outer periphery of the tray, complicating the packaging requirements. In some prior art shrimp tray packaging, the tray is disposed within an opaque, cardboard box. In such packaging, the consumer is unable to see the product that is being purchased. This can discourage a consumer from purchasing the product, or result in dissatisfaction if the purchased product does not comport with the consumer's expectations. These tray-in-a-box type of packaging also results in multiple layers of packaging, increasing the costs and refuse for each shrimp tray. Another disadvantage of this type of packaging is that it does not provide a cover to protect the shrimp until just prior to serving, and does not provide an easy method for storing a partially-consumed tray for later use.

To overcome these disadvantages, Sagan et al. (U.S. Pat. No. 6,042,856) discloses a shrimp container including a base portion that functions as a tray, and a cover that fits over the base portion. The shrimp are arranged on the tray such that they do not overhang the outer perimeter. The container disclosed by Sagan et al., however, is designed to accommodate a plurality of shrimp wherein each shrimp is oriented in a vertical plane, side-by-side with neighboring shrimp, i.e., with the tail and head ends of the shrimp oriented downwardly and the curved back elevated with respect to the ends. In this arrangement, most of the shrimp is hidden by neighboring shrimp, again making it difficult or impossible for the consumer to see the product and judge its quality and other attributes. Moreover, a substantial portion of the shrimp near the tail is disposed in a trough that extends underneath the top portion of a condiment receptacle, further obscuring the shrimp. The shrimp are further obscured by a circumferential rim that extends upwardly near the outer periphery of the tray. It will be appreciated that obscuring portions of the shrimp not only hinders the consumer's purchasing decision, but may also decrease the aesthetic display qualities of the shrimp tray when the tray is served. Sagan et al. also discloses a closure mechanism that is complicated with negative drafts along the sidewalls that are difficult to manufacture. In particular, it is not clear from the disclosure how one would engage the closure mechanism between the tray and the cover.

Accordingly, a need exists for a shrimp ring container including an integral tray and a cover that protects the shrimp, while also providing good visibility of the shrimp product, and wherein the cover is readily removable and replaceable onto the tray portion.

### SUMMARY OF THE INVENTION

The present invention is directed to a tray for packaging and serving cleaned, deveined, and precooked shrimp. The disclosed embodiment includes a tray base having an annular shelf for supporting the shrimp. An integral cup holder is provided and a condiment cup is placed in the cup holder. A removable, transparent cover is slidably disposed over the tray base, covering the shrimp supported by the annular shelf and the condiment cup. Transverse grooves divide the annular shelf into segments, the grooves being adapted to drain liquids from the shrimp. Circumferential grooves on either side of the transverse grooves receive the drained liquids. The transparent cover permits the consumer to view a substantial portion of the shrimp therethrough.

In a disclosed embodiment, the tray base sidewall includes a circumferential protrusion that engages a mating circumferential depression in the cover sidewall, thereby providing a positive engagement mechanism therebetween. In a disclosed embodiment, annular flanges are provided on the tray base and the cover, wherein the annular flanges are adjacent each other when the cover is disposed over the tray base. This configuration permits a convenient element for attaching the cover to the try base, for example, by taping or otherwise interconnecting the tray base and cover flanges.

In a disclosed embodiment, the cover includes a depression on its upper surface, and the condiment cup extends from the bottom of the cup holder approximately to the cover, thereby facilitating stacking the shrimp trays. Further, the tray base flange and the bottom of the cup holder may be coplanar at the lowermost end of the tray base, thereby providing a convenient base for the shrimp tray, with the annular wall and shrimp elevated.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a shrimp tray according to the present invention, shown with shrimp disposed on the tray;

FIG. 2 is a top plan view of the shrimp tray shown in FIG. 1;

FIG. 3 is a side elevation view of the shrimp tray shown in FIG. 1;

FIG. 4 is an exploded view of the shrimp tray shown in FIG. 1, with the shrimp omitted for clarity; and

FIG. 5 is a cross-sectional view of the shrimp tray shown in FIG. 2, taken generally from the center outwardly.

### DETAILED DESCRIPTION OF THE PREFERRED EMBODIMENT

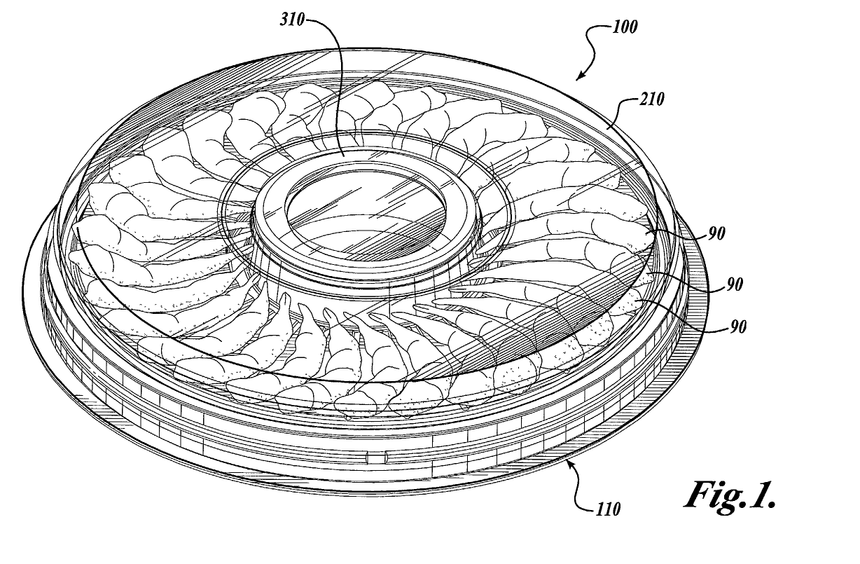

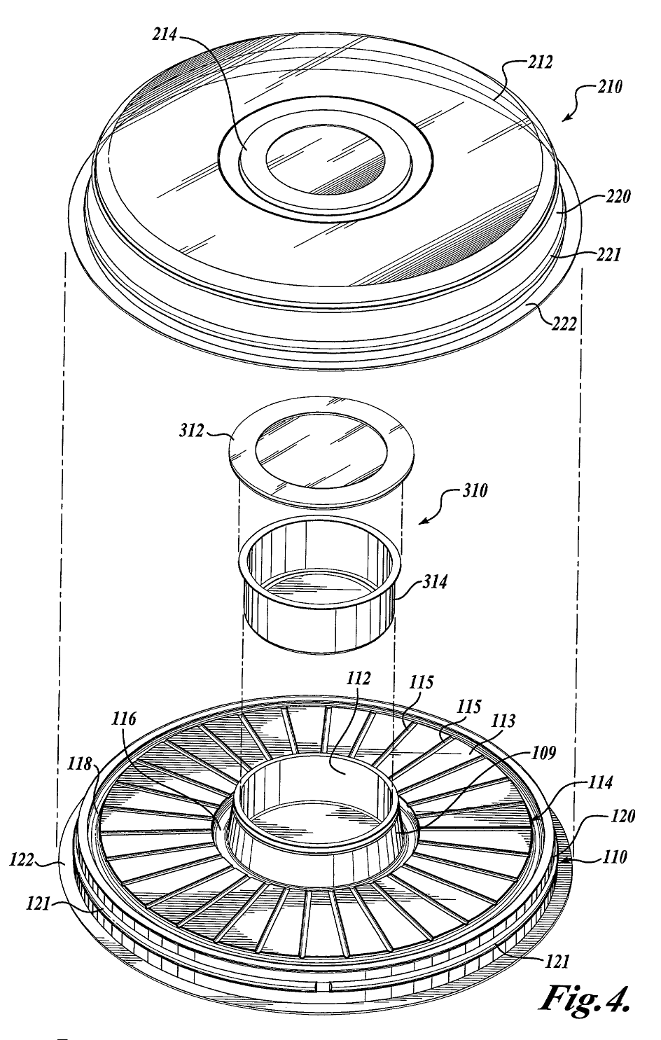

Turning now to the drawings, FIGS. 1-3 show a shrimp tray 100 according to the present invention. The shrimp tray 100 includes a preferably opaque tray base 110 that supports a plurality of shrimp 90, the shrimp 90 having a generally crescent shape and disposed on the tray base 110 resting on their sides, with the shrimp nestled with the concave portion of each shrimp 90 generally adjacent to the convex portion of a neighboring shrimp 90. A transparent cover 210 is disposed over the tray base 110, containing and protecting the shrimp 90. A removable cup assembly 310, including a cup 314 and a lid 312 (see FIG. 4), are disposed in a cup holder 112, conveniently disposed in the center of the tray base 110, as discussed below.

Referring now to FIG. 4, showing an exploded view of the shrimp tray 100 (with the shrimp omitted, for clarity), the tray base 110 includes a cup holder 112 for receiving the cup assembly 310, an annular tray shelf 114 disposed about the cup holder 112, an inner drain groove 116 and an outer drain groove 118 located along the inner radius and outer periphery of the annular tray shelf 114, respectively, an outer sidewall 120, and a flange 122. The tray shelf 114 is preferably made up of a plurality of elevated segments 113 that are separated by radial grooves 115 that extend between the inner drain groove 116 and the outer drain groove 118. In the preferred embodiment, the tray shelf 114 is substantially planar horizontally, such that the shrimp 90 disposed thereon are optimally displayed, and are not disposed to slide inwardly, as would be the case if the tray shelf 114 was inclined with a frustoconical shape. Notwithstanding the generally planar tray shelf 114, however, it will be appreciated that the circumferential drain grooves 116 and 118, cooperatively with the radial grooves 115, provide an efficient geometry for draining any accumulated liquids away from the shrimp 90.

The transparent cover 210 includes a bowl-shaped upper portion 212 that is adapted to extend over the shrimp 90, providing a cavity between the upper surface of the tray base 110 and the cover 210 that encloses and protects the shrimp 90 and the cup assembly 310. A circular cover sidewall 220 extends downwardly from the periphery of the upper portion 212, the cover sidewall being sized to fit snugly about the outer sidewall 120 of the tray base 110. A second flange 222 extends horizontally from the bottom of the cover sidewall 220, the second flange 222 adapted to generally sit atop and adjacent to the tray base flange 122. It will now be readily apparent to one of skill in the art that the tray base 110 and the cover 210 can be readily fixed together in any number of ways—for example, with tape, adhesive, heat-shrinkable material, or other wrap that connects the tray base flange 122 to the cover flange 222. Alternatively, the flanges 122, 222 may be welded or stapled together. Other means of affixing the tray base 110 to the cover 210 will be apparent to one of ordinary skill in the art, and are contemplated by this invention.

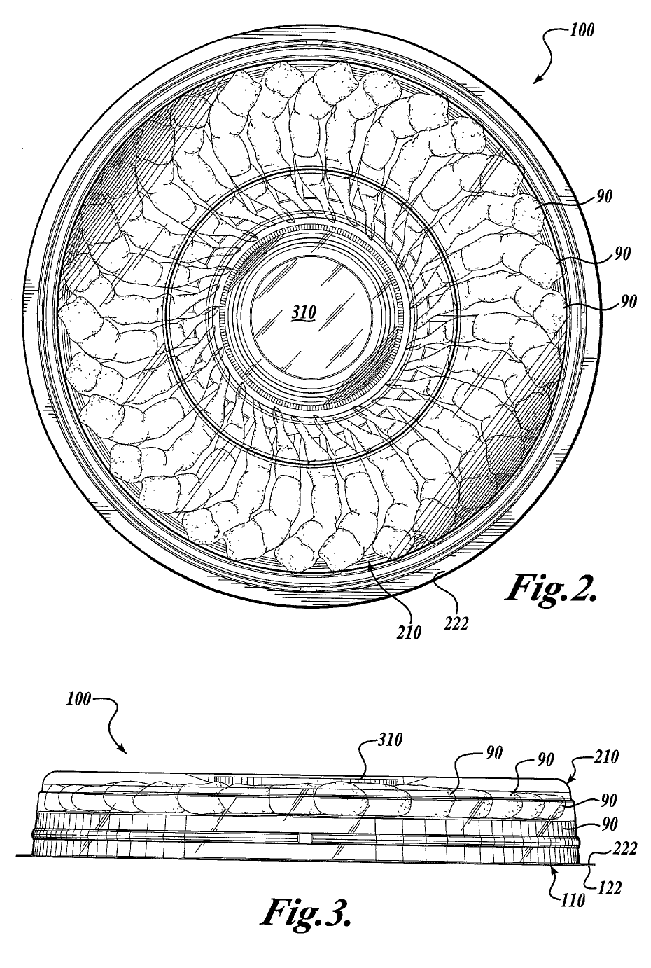

In the preferred embodiment, the top of the tray base outer sidewall 120 is approximately coplanar with the tray shelf 114. As seen most clearly in FIG. 3, showing an elevation view of the shrimp tray 100, the outer sidewall 120 does not obscure the shrimp when the shrimp tray 100 is viewed from the side. Moreover, as seen most clearly in FIG. 2, showing a plan view of the shrimp tray 100, neither the cup assembly 310 nor any adjacent shrimp 90 substantially obscure the consumer's view of the shrimp 90 from above. In particular, it will be appreciated that substantially an entire side of each of the shrimp is visible when the shrimp tray 100 is assembled, and will be displayed when the shrimp tray 100 is set out for consumption.

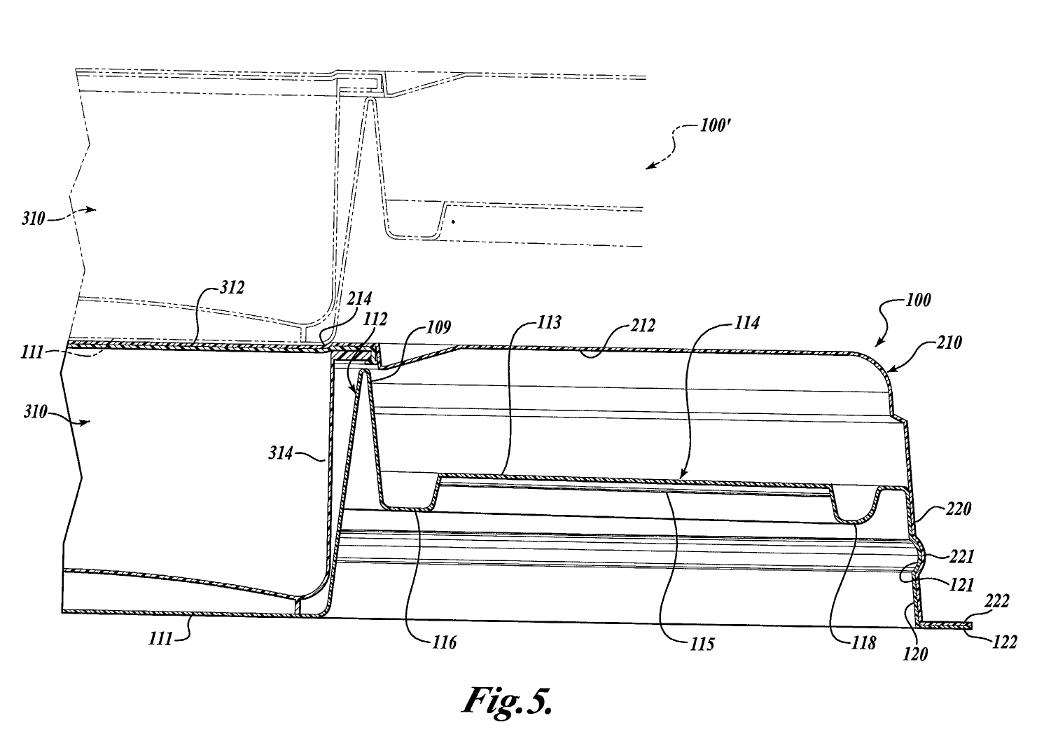

Referring now to FIG. 5, a cross-section of the shrimp tray 100 through a center plane is shown. In the preferred embodiment, the bottom 111 of the cup holder 112 is generally coplanar with the flange 122 at the base of the outer sidewall 120. The flange 122 and the cup holder 112 therefore cooperatively define a support base for the shrimp tray 100. The tray shelf 114 provides an elevated base for the shrimp 90 (not shown). Shrimp meat is not very dense, and typically the heaviest portion of the shrimp tray 100 will be the condiment cup 310 filled with condiment in the center of the tray 100. It should be appreciated, therefore, that in the preferred shrimp tray 100, the condiment cup assembly 310 extends from the tray base 111 (bottom of the cup holder) substantially to the cover 210, whereby the trays 100 can be stacked one atop the other without risk of damaging or compressing shrimp on the lower trays. A portion of a second shrimp tray 100′ is shown in phantom stacked atop the first shrimp tray 100. The cover 210 and the tray base 110 can therefore be made from a relatively lightweight material. The center of the cover 210 may also be provided with a depression 214 that is sized to accept the bottom 111 of a cup holder 112 from another tray 100′, to facilitate stacking and proper alignment of the shrimp trays 100, 100′.

The outer sidewall 120 of the tray base 110 includes a radially extending, circumferential projection 121 for engagement with the cover 210. The projection 121 may conveniently be rounded, and may be formed at the same time the other features of the tray base 110 are formed—for example, with a thermo- or vacuum-forming process, if the tray base 110 is made of a sufficiently flexible material that it can be removed from the mold without damage. Alternatively, the projection 121 may be formed on the outer sidewall 120 in a separate step. A circumferential depression 221 is formed in the cover sidewall 220, the depression being positioned and sized to engage the tray base projection 121 when the cover 210 is placed in the desired position on the tray base 110. The projection 121 and depression 221 provide an engagement mechanism between the cover 210 and the tray base 110, tending to hold the tray closed. The tray base 110 and cover 210 are preferably formed from a material having sufficient flexibility that the cover 210 can be relatively easily removed from the tray base 110.

It will also be appreciated from FIG. 5 that the radial grooves 115 on the tray shelf 114 are preferably shallower than the inner drain groove 116 and outer drain groove 118. The radial grooves 115 provide a path for liquid to drain from the shrimp 90—for example, during thawing or water remaining after rinsing the shrimp 90—with relatively large circumferential reservoirs 116, 118 that receive the water, to prevent water from dripping from the shrimp 90 during dipping and consumption.

The cup assembly 310 of the preferred embodiment comprises a cup 314 with a snap-on lid 312, such as are well known in the art. It will be appreciated that by providing the condiment in a separate container, the condiment can be packaged at a separate location and merely placed in the tray cup holder 112 when assembling the shrimp tray 100. In the preferred embodiment, the cup holder 112 in the tray base 110 includes a generally vertical wall 109 that extends higher than the annular tray shelf 114, whereby the shrimp 90 are prevented from sliding over the condiment cup 310.

It is contemplated that the shrimp tray 100 may be formed from any suitably plastic material using conventional thermoforming, injection molding, or other techniques as are well known in the industry. In particular, it will be noted that the tray base 110 of the disclosed embodiment may conveniently be formed from a single sheet of plastic material on a unitary mold without any negative drafts that would hinder removing the tray base 110 from the mold, excepting the narrow circumferential projection 121. As alluded to above, if the tray base 110 is made from a sufficiently flexible plastic material and the projection 121 is sufficiently narrow, the entire tray base 110 may be made in a single molding process. Alternatively, the projection 121 may be impressed on the tray base sidewall 120 in a separate step. Similar considerations apply to the cover 210.

Although a preferred embodiment of the invention has been described and depicted, it will be readily apparent to one of ordinary skill in the art that many variations may be made to the disclosed embodiment without departing from the present invention. For example, although a circular tray 100 has been described, the tray may alternatively be of any convenient shape, such as elliptical, polygonal (such as square or hexagonal), or irregularly shaped. Similarly, although the segmented annular tray shelf 114 is shown with a particular number of segments, many fewer, or many more, segments may be utilized including, for example, a segmented shelf having many more grooves and wherein the elevated portions and the grooves are approximately of the same width.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A shrimp tray for holding a plurality of shrimp, the shrimp tray comprising:
a tray base having an annular shelf for supporting the shrimp, the annular shelf including a plurality of radial grooves that connect an inner circumferential groove and an outer circumferential groove, the tray base further including an integral cup holder;
a condiment cup adapted to be placed in the cup holder, the condiment cup including a lid;
a removably transparent cover that engages the tray base to form a cavity cooperatively therewith for enclosing the plurality of shrimp and the condiment cup; and
wherein substantially all of at least one side of each of the plurality of shrimp is visible through the transparent cover.

2. The shrimp tray of claim 1, wherein the tray base further comprises an outer sidewall having at least one circumferentially oriented protrusion and the transparent cover further comprises an outer sidewall having at least one circumferentially oriented depression, wherein the protrusion engages the depression when the transparent cover is disposed on the tray base.

3. The shrimp tray of claim 1, wherein the tray base further comprises a first peripheral flange and the cover further comprises a second peripheral flange such that the first flange is adjacent the second flange when the transparent cover is disposed on the tray base.

4. The shrimp tray of claim 3, wherein the first flange is disposed at the bottom of the tray base, and further wherein the cup holder includes a lower panel that is generally coplanar with the first flange.

5. The shrimp tray of claim 4, wherein the transparent cover further comprises a depression at an upper surface that is sized to receive the lower panel of the cup holder of a second similar shrimp tray to facilitate stacking of the shrimp trays.

6. The shrimp tray of claim 4, wherein the condiment cup extends vertically from adjacent the lower panel of the cup holder approximately to the cover.

7. The shrimp tray of claim 1, wherein the cup holder includes a cylindrical wall that extends vertically higher than the annular shelf.

8. The shrimp tray of claim 1, wherein the tray base further comprises an outer side wall, wherein the outer side wall has an upper end that is approximately coplanar with the annular shelf such that the outer side wall does not substantially obscure the shrimp.

9. A shrimp tray for supporting a plurality of shrimp, the shrimp tray comprising:
a tray base including
a) a cup holder having a peripheral wall;
b) an annular shelf disposed about the cup holder, the shelf having an inner periphery, an outer periphery, and a plurality of grooves extending from the inner periphery to the outer periphery;
c) an inner circumferential groove disposed at the inner periphery of the shelf;
d) an outer circumferential groove disposed at the outer periphery of the shelf;
e) an outer sidewall disposed about the shelf; and
f) a flange disposed about the outer side wall;
a condiment cup adapted to be removably retained in the cup holder; and
a transparent cover adapted to be removably placed over the tray base, the transparent cover including
a) a bowl-shaped upper portion that cooperatively with the tray base defines a cavity therebetween;
b) a sidewall portion extending from the bowl-shaped upper portion, the sidewall portion sized to slidably engage the tray base outer side wall; and
c) a flange on the cover sidewall portion wherein the cover flange is adjacent to the tray base flange when the cover sidewall portion engages the tray base outer sidewall.

10. The shrimp tray of claim 9, wherein the transparent cover and tray base further comprise an engagement mechanism for positively locking the cover to the tray base.

11. The shrimp tray of claim 9, wherein the tray base outer sidewall includes at least one circumferentially oriented protrusion and the transparent cover sidewall has at least one circumferentially oriented depression, wherein the protrusion engages the depression when the transparent cover is disposed on the tray base.

12. The shrimp tray of claim 9, wherein the tray base flange is disposed at the bottom of the tray base, and further wherein the cup holder includes a lower panel that is generally coplanar with the tray base flange.

13. The shrimp tray of claim 12, wherein the transparent cover further comprises a depression at an upper surface that is sized to receive the lower panel of the cup holder of a second similar shrimp tray, to facilitate stacking of the shrimp trays.

14. The shrimp tray of claim 14, wherein the condiment cup extends vertically from adjacent the lower panel of the cup holder approximately to the cover.

15. The shrimp tray of claim 9, wherein the cup holder includes a cylindrical wall that extends vertically higher than the annular shelf.
